(19) United States
(12) Patent Application Publication
(10) Pub. No.: US 2014/0150617 A1
(43) Pub. Date: Jun. 5, 2014

(54) HOLE PUNCH WITH ALIGNMENT INDICATOR

(71) Applicants: WORKTOOLS, INC., Chatsworth, CA (US); ACCENTRA, INC., Newtown, PA (US)

(72) Inventors: JOEL S. MARKS, SHERMAN OAKS, CA (US); BRIAN E. MELGAARD, BOONTON, NJ (US)

(73) Assignees: ACCENTRA, INC., NEWTOWN, PA (US); WORKTOOLS, INC., CHATSWORTH, CA (US)

(21) Appl. No.: 13/691,567

(22) Filed: Nov. 30, 2012

(51) Int. Cl. B26F 1/02

(52) U.S. Cl. CPC B26F 1/02
USPC 83/167; 83/522.26

(57) ABSTRACT

A manually-powered, lever-operated, multi-hole punch device with visual alignment indicia, for punching holes in stacked sheet media such as paper. The hole punch device includes an elongated base with a top side divided along its length in approximate halves, with the front half being a lower flat surface transitioning through a step to a rear half, upper flat surface. The upper flat surface includes a plurality of peninsulas extending into the lower flat surface, such that the areas between the peninsulas include a visual alignment indicator. Punch elements and their punch pins are located on each peninsula overlying the lower flat surface, and the height of the step creates a slot to receive the paper stack. Underneath each punch pin on the lower flat surface is a receiving hole to receive the reciprocating punch pin. An optional chip receptacle is positioned at the underside of the base.

### BACKGROUND

The present invention relates to hole punches and sheet media punches commonly found in offices, homes, and schools. More precisely, the present invention relates to improvements to a hole punch.

Generally, the present invention is directed to a manually operated hole punch used to punch one or more holes in a stack of sheet media such as paper. Examples of such manually operated hole punches include U.S. Pat. No. 3,921,487 (Otsuka, et al.), U.S. Pat. No. 4,077,288 (Holland), and U.S. Pat. No. 6,688,199 (Godston, et al.). In such hole punch devices, a punch pin that cuts through the paper stack is slidably held in a rigid base, which receives the paper stack. The assembly of the punch pin and the rigid base is known as the punch element. The punch pin is driven through the paper stack to cut a through-hole. The paper stack fits in a slot that serves as the holding area for the punching operation. The slot is usually oriented so that it opens horizontally, and some have the slot oriented vertically. With the paper stack residing in the slot, the punch pin with its normally sharp leading edge cuts through the stack and expels the cut, disk-shaped chips on the opposite side of the stack.

The energy to drive the pin in its punching stroke originates from an actuation lever that is linked to the punch pin to advance it through the slot and paper stack. The lever is linked to a handle or it may be directly actuated by the user applying force to it or the handle. An optional return spring engaging the punch pin, lever, or handle is biased so that it assists in the withdrawal stroke of the punch pin out of the punched hole. In order for the hole in the paper stack to be punched neatly and in alignment with one another, the loose stack of papers must itself be neatly aligned and positioned in the device before being punched.

There have been efforts to neatly align a stack of papers inside the slot to ensure the punched holes are aligned with the edge of the papers and spaced apart as desired. Examples include U.S. Patent Application Publication No. 2007/0251367 (Hermance, et al.) and European Patent Application Publication No. EP1332847 B1 (Gardner, et al.).

### SUMMARY OF THE INVENTION

The present invention is directed to a manually powered punch device for cutting holes in sheet media, such as a sheet or stack of papers. In a preferred embodiment, the manually powered punch device for cutting holes in sheet media comprises a base having a top side with an upper flat surface at a rear of the base transitioning to a lower flat surface at the front of the base, wherein the upper flat surface includes a plurality of peninsulas extending into and raised above the lower flat surface. There are a plurality of punch elements each having a punch pin and aligned in a row, wherein each punch element is supported on a respective peninsula with the punch element and punch pin overlying the lower flat surface. A slot is formed between the overlying punch element and the lower flat surface, the slot being open toward the front of the base. A plurality of pin holes located on the lower flat surface are aligned underneath each punch pin. A handle or lever engages the plurality of punch elements to actuate the punch pins, wherein the distal end of the lever extends toward a rear of the base. Alignment indicia are disposed in between the peninsulas on the lower flat surface, and an optional, removable chip tray is disposed underneath the pin holes at an underside of the base.

In various alternative embodiments, the manually powered punch device may include alignment indicia that includes a straight stripe of ink, and wherein the alignment indicia may include a linear stripe of paint, wherein the device may further include three punch elements, three punch pins, three peninsulas, and three pin holes, wherein the three punch elements and peninsulas are evenly spaced apart. In other alternative embodiments, the manually powered punch device includes a lever that has enlarged recesses, and wherein the recesses extend rearward so that the alignment indicia are visible through the recesses.

These and other aspects, features, and advantages of the present invention will become apparent from the following detailed description of the preferred embodiments which, taken in conjunction with the accompanying drawings, illustrate by way of example the principles of the invention.

### BRIEF DESCRIPTION OF THE DRAWINGS

FIG. 1 is a perspective view of a preferred embodiment hole punch with multiple punch elements.

FIG. 2 is a perspective view of the hole punch from FIG. 1 with the lever removed.

FIG. 3 is a perspective view of the hole punch of FIG. 1 with a sheet of paper or the like inserted therein and properly aligned using the alignment indicia.

FIG. 4 is an exploded view of the hole punch of FIG. 1 showing the major component parts.

FIG. 5 is a top plan view of the hole punch of FIG. 1 with the lever removed to show the alignment mechanism for the paper stack.

### DETAILED DESCRIPTION OF THE PREFERRED EMBODIMENTS

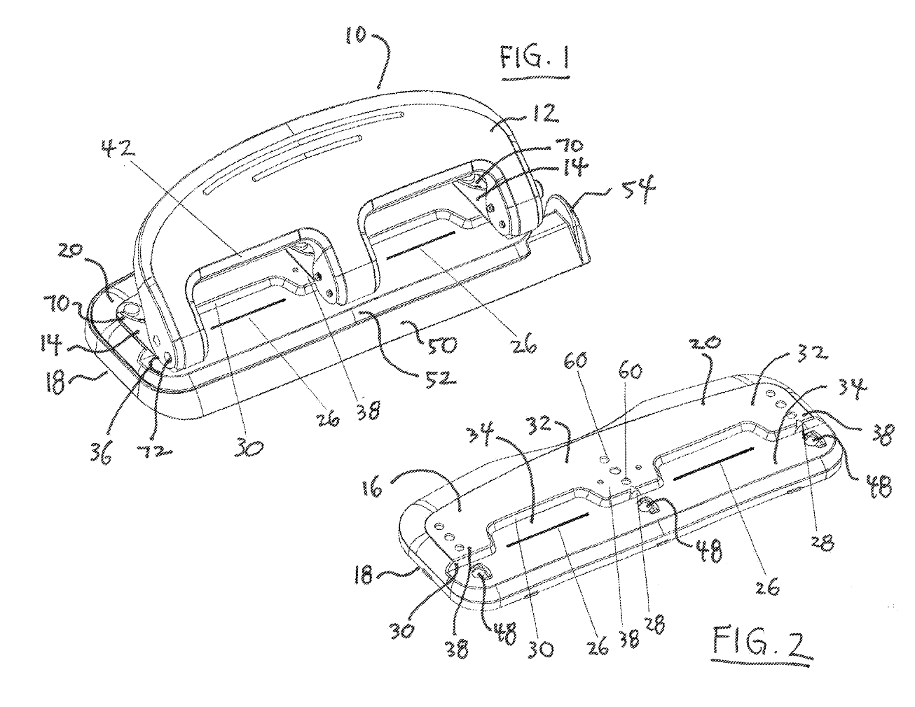

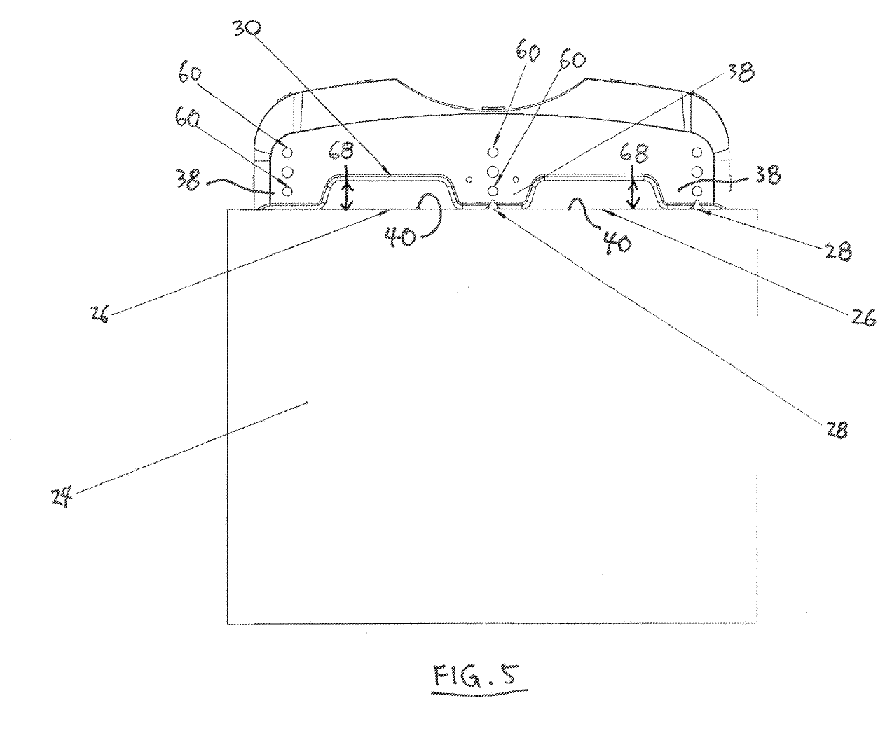

FIGS. 1 to 4 show a preferred embodiment of a manually operated three-hole punch device 10. The hole punch device is used to punch three holes in a loose stack of sheet media such as paper, cardboard, plastic film, etc. The hole punch device 10 shown in FIG. 1 is manually operated via handle or lever 12. The lever 12 through user hand pressure drives the three hole punch pins 44 inside punch elements 14, as best seen in FIG. 4. The three hole punch elements 14 are aligned in a row and connected to an elongated frame or base 20. The base 20 has an elongated shape with a slightly contoured top side 16 and a bottom side 18, as best seen in FIG. 2. An optional chip receptacle 22 to receive paper chips generated from the punching operation is located on the bottom or underside 18 of the base 20. Punch pins 44 inside the punch elements 14 advanced by lever action cut holes when the paper stack is inserted into a paper slot 36.

As seen in FIGS. 1, 3, and 5, the punch device 10 includes at the top side 16 alignment indicia/alignment indicator 26 (located on lower flat surface 34) that help the user line up the vertical edge 40 of a paper stack 24 with the punch elements 14 so that the row of three punched holes are precisely aligned and typically parallel to the edge 40 of the paper stack 24. The paper stack 24 can be of any size and preferably polygonal as in a rectangle or square, but in the exemplary embodiments, each sheet measures 8.5 inches horizontally and 11 inches vertically. If the punched row of holes is not aligned with the vertical edge 40 of the paper stack 24, the punched paper stack 24 when placed inside a three-ring binder, for example, will not be neatly and uniformly aligned inside the binder. This is unsatisfactory performance of the punch device for many users.

As seen in FIG. 5, one or more stops 28 with a flat face or wall are present to abut the vertical edge 40 of the paper stack 24. The stops 28 together with the alignment indicia 26 help the user ensure that the paper stack 24 is fully inserted into the slot 36 such that the punched holes are produced consistently the same distance from the vertical edge 40. To do this, first, the stops 28 minimize over-insertion of the paper in the slot 36. Also, the vertical face of stops 28 prevent the paper stack from becoming “unstacked” (i.e., skewed where the top sheet is farther in than the bottom sheet).

Second, the alignment indicia 26 prevent over-insertion of the paper stack into the slot 36 where the holes are created too far horizontally into the paper stack, via visual feedback. If the papers are over-inserted into the slot 36, the alignment indicia 26 will be covered up indicating to the user lack of proper alignment. The stops 28 add a tactile feedback to the user as well.

Third, the alignment indicia 26 prevent under-insertion of the paper stack into the slot 36 where the holes are created horizontally too close to the edge 40, by giving the user visual cues when the vertical edge 40 of the paper stack is not flush with the alignment indicia 26. Fourth, the alignment indicia 26 further minimize the incident of a paper stack 24 being inserted in a crooked or skewed state inside the slot 36 which would produce a row of holes not parallel to the vertical edge 40.

In alternative embodiments, stops 28 may be located to the rear of the alignment indicia 26 (i.e., to the left in FIG. 5), or omitted if it is desired to provide an option to move the paper stack past the alignment indicia 26. When stops 28 allow additional clearance, vertical edge 40 may be moved to different selected aligned positions. Then the hole locations can be farther inward, for example, to the right in FIG. 5 from edge 40.

A vertical face or walled stop 54 at one end of the receptacle 22 (or base 20 in an alternative embodiment) ensures the row of punched holes are located consistently at the desired distance from the horizontal edge 56 of the paper stack 24. These mechanisms ensure that the user produces with the present invention hole punch device 10 consistent, precise, and repeatably aligned three-hole punched paper stacks 24 that neatly and uniformly fit into a three ring binder or the like. In an alternative embodiment, the horizontal position of stop 54 may be adjustable to allow varying relative hole positions or vertical paper sizes.

It is contemplated that the present invention hole punch device 10 be suitable for use with different sizes of sheet media aside from the 8.5″×11″ paper described, including different shapes such as a square or rectangle, and cutting the holes along the top or bottom edge, or along a left or right side edge. It is further contemplated that the hole punch device be adapted to use with sheet media of different thicknesses, different materials such plastic, and different stack heights.

As seen in FIGS. 1 and 2, a vertical step 30 divides the top side 16 into an upper flat surface 32 at the rear of the base 20 and a lower flat surface 34 at the front of the base 20. The two surfaces 32, 34 are preferably parallel. The front of the base 20 is the area where the paper stack 24 is inserted into the slot 36 and the leading edge preferably includes a ramp 50, 52 to help guide the paper stack 24 onto upper flat surface 32 and into the slot 36. As seen in FIG. 1, the proximal rear portion 70 of the punch element 14 is mounted to the upper flat surface 32, and the front distal portion 72 of the punch element 14 overlies the lower flat surface 34. Punch pins 44 inside the punch elements 14, advanced by manual lever action to pass through the slot height/step 30, cut through the paper stack 24 contained therein, and proceed into respective pin holes 48 formed in the lower flat surface 34. Therefore, the vertical distance from the upper flat surface 32 to the lower flat surface 34 generally defines the height opening of the paper slot 36. In the preferred embodiment, the height opening of the slot 36 also coincides with the height of the step 30. The mouth or opening of the paper slot 36 faces the front of the base 20 at ramp 50, 52.

The upper and lower flat surfaces 32, 34 each generally defines a relative level of such surfaces. Although generally flat, the surface may include protrusions, contours, embosses, holes, or other locally non-flat features at the general level of the respective surface.

In conventional multi-hole punches, as seen from a top plan view similar to that of FIG. 5, the step forms a straight line (not shown in FIG. 5) along the hole punch device length and generally coincides with the paper stop position. The base is thus divided into two separate levels with an offset, transition, or step therebetween. This simple form is easy and common to produce by a sheet metal forming operation. The step formed by stamped sheet metal is necessarily shaped with a gradual, radiused profile, and such a sloped, rounded profile is too ambiguous to be useful as a visual alignment indicator. Even if the base were molded or cast, there is always a curvature at the step due to fabrication and tooling limitations.

Conventional punches rely on the sloped, radiused step to act as a stop. But then the sloped face of the step when abutting the edge of a stack of papers does not effectively ensure alignment since the paper edge may bend and pass over the sloped step, the sheets of paper may distort, and/or the user might not recognize through tactile feedback that the paper stack has fully engaged the step and keep pushing the paper stack farther into the slot. The end result is punched holes that are misaligned or skewed with the paper edge.

Thus, providing alignment indicia 26 according to a preferred embodiment of the present invention as an imprinted line is highly advantageous. But it is still impractical, expensive, and undesirable to print, etch, mark, or likewise lay down an indicator line on a sloped, radiused step 30.

As seen in the top plan view of FIG. 5, the preferred embodiment has two sections of the step 30 set back between the punch elements 14 to form a supporting peninsula 38 at each of the three punch elements 14. Set back distance 68 is shown in FIG. 5. The three peninsulas 38 are thus formed as part of the upper flat surface 32 that extend toward the front of the base 20 and transition through the step 30 to the lower flat surface 34. Even with the peninsulas 38, there remain two generally separate levels of the base 20 divided between the front half and rear half. The front and rear halves are only preferred embodiment approximations, so other proportions are contemplated. The base 20 thus retains the ease and low cost of manufacture of the simple, offset level structure.

In the set back regions in between the peninsulas 38, the lower flat surface 34 extends rearward over distance 68 past the stop 28 position, so on these flat areas it is possible to clearly render one or more alignment indicators/indicator lines 26. As better seen from the top plan view of FIG. 5, step 30 incorporating the peninsulas 38 forms a serpentine path along the length of the base 20 dividing the top side 16 into an upper flat surface 32 at the rear and a lower flat surface 34 at the front, wherein areas of the lower flat surface 34 between the peninsulas 38 enable one or more visible indicator lines 26 to be to printed, inked, painted, etched, grooved, laser cut, stamped, embedded with a separate and reflective component, adhesive stickered, and/or similarly marked. The indicator line 26 is preferably a distinct or contrasting color from the background color of the surface 34. The indicator line 26 may be created using an ink or material having high light reflectivity, with a sufficient width to be readily discernible by the casual observer. With the set back regions on the lower flat surface 34 between the peninsulas 38, a good foundation is thus created.

To further enhance the user's ability to see and use the alignment indicator 26 to align the edge of the paper stack 40 with it, the preferred embodiment lever 12 has several enlarged recesses or cut-outs 42 formed into its front edge. These recesses 42 give the user direct line-of-sight to the alignment indicia 26 while minimizing the lever 12 blocking that line-of-sight regardless of the pivoting lever's angular position.

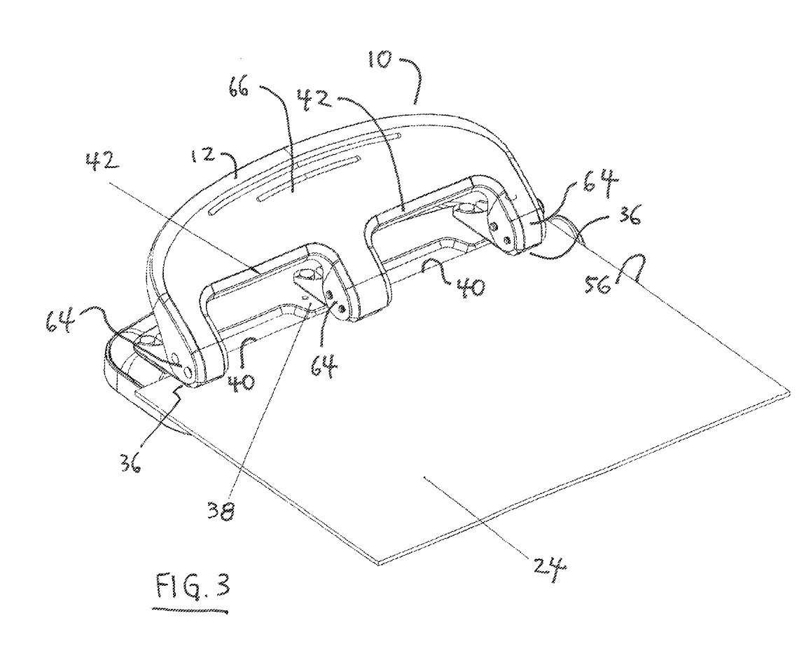

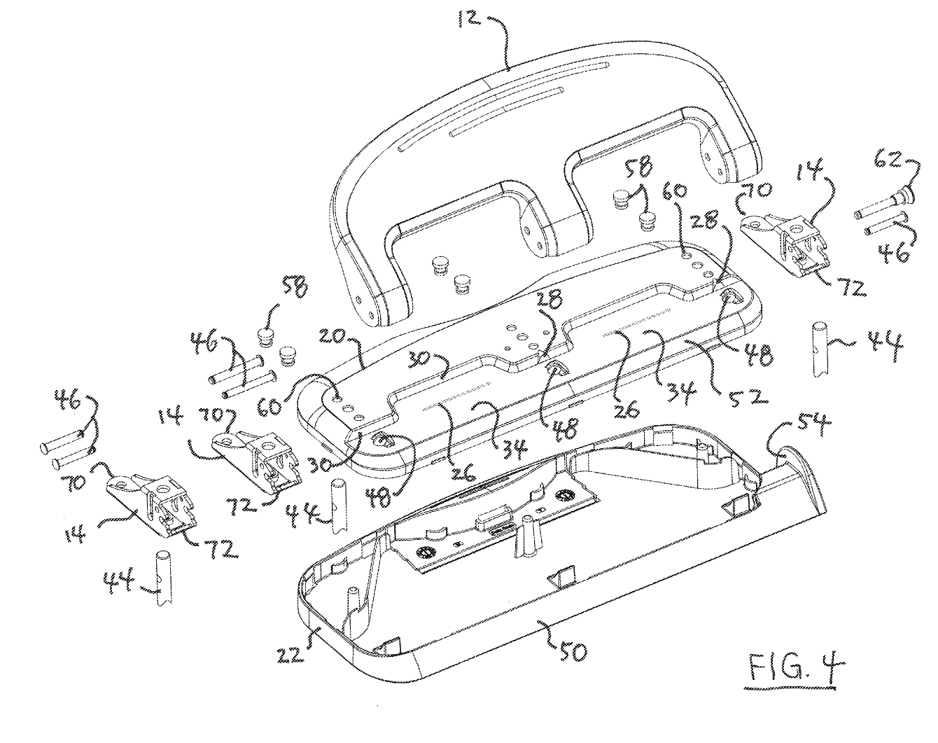

The enlarged recesses 42 are preferred by virtue of the orientation of the lever 12. As seen in FIG. 3, the exemplary embodiment lever 12 is hinged at the punch element locations 64 and the distal end 66 of lever 12 rises up away from the paper stack 24. The lever cut-outs or recesses 42 are located in between the hinge locations 64. Hence, the enlarged recesses 42 at the proximal edge of the lever 12 enable the user to see the paper insertion and alignment. In contrast, conventional hole punch levers are oriented in the opposite direction, with the lever hinged at the punch element but with the free distal end extending toward and overlying the paper stack. This orientation, with the distal end of the lever overlying the paper stack, locates the lever and the user's hand on the lever within and blocking the line of sight of the slot where the paper alignment takes place.

The preferred embodiment lever orientation and its pivot location 64 also improve the user's view. Specifically, the preferred embodiment lever 12 is pivotally mounted at location 64 to punch element 14 (or alternatively to base 20, not shown) at a position directly above and overlying the paper stack 24 in FIG. 3. The punch element 14 has a proximal end 70 and a distal end 72, as seen in FIG. 4. The proximal end 70 is riveted, welded, or similarly mounted to the peninsula 38 and the distal end 72 where the punch pin 44 is held extends over the lower flat surface 34. Thus, the lever-punch element mounting location 64 is positioned in front of the forward tips of peninsulas 38, and also in front of the row of punch pins 44. When the user's hand is placed on the lever 12 at the panel-like distal end 66 to press the lever 12, the hand is located to the rear of the slot 36 and away from the paper stack 24. Thus, the paper edge 40 and the alignment indicia 26 are clearly visible to the user through recesses 42 before, during, and after an operating stroke of the lever 12.

FIG. 4 is an exploded view of the preferred embodiment three-hole punch device 10 from FIG. 1. FIG. 4 shows the elongated base 20 with the bottom receptacle 22 removed. The receptacle 22 includes an optional sloped leading edge 50 that transitions to a similarly sloped leading edge 52 of the base 20. The sloped leading edge of the base 20 then transitions to the lower flat surface 34, so the slopes act as a ramp for the paper stack 24, thus guiding the edge 40 of the paper stack into the mouth of the slot 36. An edge stop 54 is provided at one end of the receptacle 22 to help with vertical alignment of the loose paper stack 24. An optional lock pin 62 slides into (and out of) a receiving hole in the punch element 14 to lock (or release) the lever 12 in a down position for compact transport.

In FIG. 4, the three punch elements 14 are shown with the punch pins 44 separated. Pivot pins 46 translate the lever action to advance and withdraw the punch pins 44 into and out of the respective pin holes 48 located in the lower flat surface 34. A variety of assembly rivets, pins, and mechanical fasteners 58 and their respective receiving holes 60 are located throughout the device 10 to join the major components together. Of course, assembly can be accomplished via many methods such as spot welding, bonding, adhesives, fasteners, etc. A coiled reset spring used to reset the lever 12 to the start position and to retract the punch pins 44 has been omitted from the drawing figures along with some other minor hardware to simplify the views.

Although the present invention has been described in terms of certain preferred embodiments, other embodiments that are apparent to those of ordinary skill in the art are also within the scope of the invention. For example, the exemplary embodiment is directed to a three-hole punch, but a two-hole punch or more than three-hole punches are contemplated. Components and features of one embodiment may be combined with other embodiments. Accordingly, the scope of the invention is intended to be defined only by reference to the appended claims. While variations have been described and shown, it is to be understood that these variations are merely exemplary of the present invention and are by no means meant to be limiting.

We claim:

1. A manually powered punch device for cutting holes in sheet media, comprising:
a base having a top side with an upper flat surface transitioning to a lower flat surface, wherein the upper flat surface includes a plurality of peninsulas extending into and raised above the lower flat surface;
a plurality of punch elements each having a punch pin and aligned in a row, wherein each punch element is supported on a respective peninsula with the punch element and punch pin overlying the lower flat surface;
a slot formed between the overlying punch element and the lower flat surface, the slot being open toward a front of the base;
a plurality of pin holes located on the lower flat surface and aligned underneath each punch pin;
a lever engaging the plurality of punch elements to actuate the punch pins, wherein the lever extends toward a rear of the base;
alignment indicia disposed in between the peninsulas on the lower flat surface; and
a chip tray disposed underneath the pin holes at an underside of the base.

2. The manually powered punch device of claim 1, wherein the alignment indicia includes a straight stripe of ink disposed thereon.

3. The manually powered punch device of claim 1, wherein the alignment indicia includes a linear stripe of paint.

4. The manually powered punch device of claim 1, wherein the device includes three punch elements, three punch pins, three peninsulas, and three pin holes, wherein the three punch elements and peninsulas are evenly spaced apart.

5. The manually powered punch device of claim 1, wherein the device includes at least one alignment indicia located in between the peninsulas on the lower flat surface.

6. The manually powered punch device of claim 1, wherein the lever includes enlarged recesses, and wherein the recesses extend rearward so that the alignment indicia are visible through the recesses.

7. The manually powered punch device of claim 1, wherein a flat-faced stop is located within the slot at the peninsula.

8. The manually powered punch device of claim 1, wherein each punch element is affixed to the peninsula at a proximal portion and overlies the lower flat surface at a distal portion, and the lever is hinged proximate the distal portion.

9. The manually powered punch device of claim 1, wherein each peninsula extends in the same direction onto the lower flat surface.

10. A manually powered punch device for cutting holes in sheet media, comprising:
a base having an elongated length;
the base with a generally planar top side having an upper flat surface at a rear transitioning to a lower flat surface at the front, the transition extending along the length of the base, wherein the upper flat surface includes a plurality of peninsulas extending into the lower flat surface;
a plurality of punch elements supported on the respective peninsulas, each punch element including a punch pin with a longitudinal axis, wherein the punch elements overlie and are spaced apart from the lower flat surface of the base forming a slot therebetween, and the longitudinal axis of each punch pin is perpendicular to the lower flat surface;
a plurality of pin holes disposed on the lower flat surface, each pin hole aligned and receiving a respective punch pin therein;
a lever engaging the plurality of punch elements to actuate the punch pins, wherein the lever extends distally toward the rear of the base;
a flat-faced stop disposed at the peninsula within the slot; and
linear alignment indicia extending along the length of the base in between the peninsulas on the lower flat surface.

11. The manually powered punch device of claim 10, wherein the upper and lower flat surfaces are parallel.

12. The manually powered punch device of claim 10, wherein the alignment indicia includes at least one of an ink stripe, a paint stripe, an elongated groove, an elongated insert, and an elongated adhesive strip.

13. The manually powered punch device of claim 10, wherein the alignment indicia includes at least one painted white stripe.

14. The manually powered punch device of claim 10, wherein the lever includes enlarged recesses at a front edge to minimize blocking a view of the alignment indicia.

15. The manually powered punch device of claim 10, wherein the plurality of peninsulas rising from the lower flat surface forms a serpentine pattern between the upper flat surface and the lower flat surface.

16. The manually powered punch device of claim 10, wherein the base includes a leading edge slope merging with the lower flat surface.

17. A manually powered punch device for cutting holes in sheet media, comprising:
a base having a top side with an upper flat surface at the rear transitioning to a lower flat surface at the front, wherein the upper flat surface includes a plurality of peninsulas extending in the same direction into and raised above the lower flat surface;
a plurality of punch elements each having a punch pin aligned in a row, wherein each punch element is supported at a proximal portion on a respective peninsula with a distal portion of the punch element overlying the lower flat surface;
a slot formed between the distal portion of the punch element and the lower flat surface with an opening facing the front of the base;
a plurality of pin holes located on the lower flat surface and aligned underneath each punch pin;
a lever having a proximal end and a distal end, wherein the proximal end is hinged to the distal portion of the punch element and engages the plurality of punch elements to actuate the punch pins, and the distal end of the lever extends toward the rear of the base;
linear alignment indicia disposed in between the peninsulas on the lower flat surface; and
a chip tray disposed underneath the pin holes at an underside of the base.

18. The manually powered punch device of claim 17, wherein the linear alignment indicia includes a straight line marked on the lower flat surface.

19. The manually powered punch device of claim 17, wherein the lever includes enlarged recesses located at a front of the lever.

20. The manually powered punch device of claim 17, wherein the linear alignment indicia are parallel to the aligned row of punch elements.
